(19) United States
(12) Patent Application Publication
(10) Pub. No.: US 2024/0372068 A1
(43) Pub. Date: Nov. 7, 2024

(54) HYDROPHILIC LITHIUM METAL COMPOSITE ANODE AND METHODS OF MAKING SAME

(71) Applicant: Soelect Inc., Greensboro, NC (US)

(72) Inventor: Sungjin CHO, Summerfield, NC (US)

(21) Appl. No.: 18/683,306

(22) PCT Filed: Oct. 24, 2022
(86) PCT No.: PCT/US2022/047607

§ 371 Date: Feb. 13, 2024

Related U.S. Application Data
(60) Provisional application No. 63/271,120, filed on Oct. 23, 2021.

(51) Int. Cl. H01M 4/134; H01M 4/02; H01M 4/04; H01M 4/1395; H01M 4/38; H01M 4/62; H01M 10/42

(52) U.S. Cl. CPC H01M 4/134; H01M 4/0402; H01M 4/1395; H01M 4/382; H01M 4/62; H01M 10/4235; H01M 2004/027

(57) ABSTRACT

A method of forming a lithium metal composite anode for a battery is disclosed. One method includes providing a portion of lithium metal and adding at least one type of hydrophilic matter to a portion of lithium metal to adhere or embed the at least one type of hydrophilic matter to or into the portion of lithium metal to form a lithium metal composite anode.

### CROSS-REFERENCE TO RELATED APPLICATION

This application is based on and claims priority to U.S. Provisional Patent Application No. 63/271,120 filed Oct. 23, 2021, the disclosure of which is incorporated by reference herein in its entirety.

### FIELD OF THE DISCLOSED SUBJECT MATTER

The disclosed subject matter herein pertains to metal anodes in energy storage devices generally, and more particularly pertains to lithium metal anodes suited for use in electrochemical storage devices such as batteries and other applications.

### BACKGROUND

Lithium metal has a high capacity and is easily engineered. Lithium metal is one of the most promising high energy and power anode material for next generation electronic devices as well as electric vehicles due to its nearly ten times higher specific capacity of 3860 milliamps/grams (mAh/g) than graphite and its lowest redox electrochemical potential of −3.04 Volts (V) (as compared to a standard hydrogen electrode). These properties make lithium metal a promising and attractive material for use as an anode in next generation batteries with applications in electric vehicles (EVs), information technology (IT) electronics, energy storage, and many other technologies. However, a common problem associated with lithium in conventional battery technology is that the metal is prone to form dendrites. Dendrites are small whiskers of lithium metal that form on the surface of the electrode. Notably, the formation of dendrites can lead to poor battery performance, low Coulombic efficiency, poor cycle life, electrochemical and thermal instability and short circuits, which in turn can cause a battery to overheat and/or combust into flames. Furthermore, the lithium metal used to make these types of batteries is an innately hydrophobic material, and thus, extremely difficult to wet with liquid electrolytes. In addition, the configuration necessary for a battery cell electrode to provide a high energy density further hinders the electrode's ability to absorb liquid electrolyte.

Thus, because an electrode's ability to absorb liquid electrolyte plays a critical role in the overall performance of a battery cell, there currently exists a need in the art for enhancing the wettability of a battery electrode.

### SUMMARY

The subject matter described herein includes hydrophilic lithium metal composite anodes and method of making the same. One example method includes providing a portion of lithium metal and adding at least one type of hydrophilic matter to the portion of lithium metal to adhere or embed the at least one type of hydrophilic matter to or into the portion of lithium metal to form a lithium metal composite anode.

According to an example of the subject matter described herein, a method wherein the lithium metal composite anode exhibits hydrophilic properties.

According to an example of the subject matter described herein, a method wherein the at least one type of hydrophilic matter comprises particles of one or more of a hydroxyl (—OH) group, a carbonyl (—C═O) group, a carboxyl (—COOH) group, and amino group, a sulfhydryl group, a phosphate group, an ether linkage, an ester linkage, a phosphodiester linkage, a glycosidic linkage, a peptide bond, an amino (—NH₂) structure, an ammonia/ammonium (═NH) structure, and ammonium cations (NR⁴⁺).

According to an example of the subject matter described herein, a method wherein a portion of an electrolyte applied to the lithium metal composite anode interfaces with a surface of the lithium metal composite anode at a contact angle less than ninety (90) degrees.

According to an example of the subject matter described herein, a method wherein the electrolyte includes a carbonate-based liquid electrolyte, an ether-based liquid electrolyte, an ionic liquid electrolyte, or a polymer electrolyte including a free-standing electrolyte membrane.

According to an example of the subject matter described herein, a method wherein the electrolyte includes a polymer-based electrolyte comprising a plasticizer.

According to an example of the subject matter described herein, a method wherein the at least one type of hydrophilic material is added to the portion of lithium metal via electrostatic spray deposition (ESD), brushing, atomic layer deposition (ALD), molecular layer deposition (MLD), chemical vapor deposition (CVD), physical vapor deposition (PVD), sputtering, evaporation, spin coating, thermal evaporation, stamping, or combinations thereof.

According to an example of the subject matter described herein, a method wherein the portion of lithium metal comprises pure lithium metal, a lithium composite, a lithium alloy, or a lithium metal supported by a polymer substrate.

According to an example of the subject matter described herein, a method wherein the at least one type of hydrophilic matter is dispersed and embedded throughout the portion of lithium metal.

In some embodiments, an example lithium metal composite anode includes a portion of lithium metal and at least one type of hydrophilic matter, wherein the at least one type of hydrophilic matter is added to the portion of lithium metal to adhere or embed the at least one type of hydrophilic matter on or in the portion of lithium metal.

According to an example of the subject matter described herein, a lithium metal composite anode wherein the addition of the at least one type of hydrophilic matter to the portion of lithium metal produces a lithium metal composite anode that exhibits hydrophilic properties.

According to an example of the subject matter described herein, a lithium metal composite anode wherein the at least one type of hydrophilic matter comprises particles of one or more of a hydroxyl (—OH) group, a carbonyl (—C═O) group, a carboxyl (—COOH) group, and amino group, a sulfhydryl group, a phosphate group, an ether linkage, an ester linkage, a phosphodiester linkage, a glycosidic linkage, a peptide bond, an amino (—NH2) structure, an ammonia/ammonium (═NH) structure, and ammonium cations (NR4+).

According to an example of the subject matter described herein, a lithium metal composite anode wherein a portion of an electrolyte applied to the lithium metal composite anode interfaces with a surface of the lithium metal composite anode at a contact angle less than ninety (90) degrees.

According to an example of the subject matter described herein, a lithium metal composite anode wherein the electrolyte includes a carbonate-based liquid electrolyte, an ether-based liquid electrolyte, an ionic liquid electrolyte, or a polymer electrolyte including a free-standing electrolyte membrane.

According to an example of the subject matter described herein, a lithium metal composite anode wherein the electrolyte includes a polymer-based electrolyte comprising a plasticizer.

According to an example of the subject matter described herein, a lithium metal composite anode wherein the at least one type of hydrophilic material is added to the portion of lithium metal via electrostatic spray deposition (ESD), brushing, atomic layer deposition (ALD), molecular layer deposition (MLD), chemical vapor deposition (CVD), physical vapor deposition (PVD), sputtering, evaporation, spin coating, thermal evaporation, stamping, or combinations thereof.

According to an example of the subject matter described herein, a lithium metal composite anode wherein the portion of lithium metal comprises pure lithium metal, a lithium composite, a lithium alloy, or a lithium metal supported by a polymer substrate.

According to an example of the subject matter described herein, a lithium metal composite anode wherein the at least one type of hydrophilic matter is dispersed and embedded throughout the portion of lithium metal.

In some embodiments, an example batter cell comprises a cathode, an electrolyte, a separator containing the electrolyte, and a lithium metal composite anode, which includes a portion of lithium metal and at least one type of hydrophilic matter, wherein the at least one type of hydrophilic matter is added to the portion of lithium metal to adhere or embed the at least one type of hydrophilic matter on or in the portion of lithium metal, and wherein the lithium metal composite anode exhibits hydrophilic properties when in contact with the electrolyte.

According to an example of the subject matter described herein, a battery cell wherein the lithium metal composite anode is incorporated within a lithium-ion battery cell, a lithium metal battery cell, a polymer-electrolyte based all solid-state battery cell, a lithium sulfur battery cell, a lithium air battery cell, or the like.

### BRIEF DESCRIPTION OF THE DRAWINGS

FIG. 1 is a schematic illustration of a lithium metal composite anode that includes hydrophilic matter embedded on the surface of a lithium metal film layer in accordance with the disclosed subject matter;

FIG. 2 is a schematic illustration of a lithium metal composite anode that includes a layer of hydrophilic matter embedded between two layers of lithium metal film in accordance with the disclosed subject matter;

FIG. 3 is a schematic illustration of a lithium metal composite anode that includes hydrophilic matter embedded and dispersed throughout a lithium metal film in accordance with the disclosed subject matter;

FIG. 4 is a schematic depicting the contact angles of a hydrophilic surface and a hydrophobic surface in accordance with the disclosed subject matter:

FIG. 5 is a schematic illustration of an example process for making a lithium metal composite anode in accordance with the disclosed subject matter:

FIG. 6 is a schematic illustration of an alternate example process for applying a liquid lubricant containing hydrophilic matter to lithium metal in accordance with the disclosed subject matter:

FIG. 7 is a schematic illustration comparing the discharge capacity retention rates of a hydrophobic lithium metal anode and a hydrophilic lithium metal composite anode in accordance with the disclosed subject matter:

FIG. 8 is a schematic illustration comparing the surfaces of a hydrophobic lithium metal anode and a hydrophilic lithium metal composite anode in accordance with the disclosed subject matter:

FIG. 9 is a schematic illustration comparing the impedance characteristics of a hydrophobic lithium metal anode and a hydrophilic lithium metal composite anode in accordance with the disclosed subject matter:

FIG. 10 is a schematic illustration comparing the voltage instability of a hydrophobic lithium metal anode and a hydrophilic lithium metal composite anode in accordance with the disclosed subject matter:

FIG. 11 is a schematic illustrating various types of structures of hydrophilic matter in accordance with the disclosed subject matter; and

FIG. 12 is a block diagram of an example battery cell that includes a hydrophilic lithium metal anode in accordance with the disclosed subject matter.

### DETAILED DESCRIPTION

The disclosed subject matter concerns lithium metal composite anodes that include at least one type of hydrophilic matter, which is applied to (e.g., adhered, added, and/or embedded on or throughout) the lithium metal portion of the anode. Notably, the at least one type of hydrophilic matter may include one or more of i) particles of solid matter, ii) particles of liquid matter, and/or iii) particles of gaseous matter. Further, the hydrophilic matter may be applied to the portion of lithium metal via one or more application techniques as discussed below. In some embodiments, the hydrophilic matter comprises either metallic hydrophilic matter, non-metallic hydrophilic matter, or mixtures thereof. When applied to the portion of lithium metal, the hydrophilic matter can cause a liquid (e.g., liquid electrolyte, water, polymer electrolytes with plasticizer, etc.) to form a contact angle of less than 90 degrees on the surface of the disclosed lithium metal composite. In some embodiments, the hydrophilic matter may be soluble or insoluble (albeit dispersible) in liquid electrolytes.

In one example embodiment, the lithium metal composite anode(s) of the disclosed subject matter may be prepared by distributing particles of the hydrophilic matter directly onto a portion of lithium metal, or indirectly via a polymer substrate, adding a portion of lithium metal or polymer substrate over the particles to form a laminate, and introducing the laminate into a nip formed between two rollers in a press to add, press, and/or embed the hydrophilic matter at least partially into the portion of lithium metal. Although the lithium metal composite anode is described herein as using a portion of pure lithium metal, other lithium metal types including, but not limited to, a lithium composite, a lithium alloy, or a lithium metal supported by a polymer substrate can be used without departing from the scope of the disclosed subject matter.

In some example embodiments discussed below, a lithium metal composite anode can be prepared by using an electrostatic spray deposition (ESD) technique to apply the hydrophilic matter to the surface of the portion of the lithium metal, wherein particles of the hydrophilic matter adhere to or embed into the lithium metal via absorption and/or adsorption.

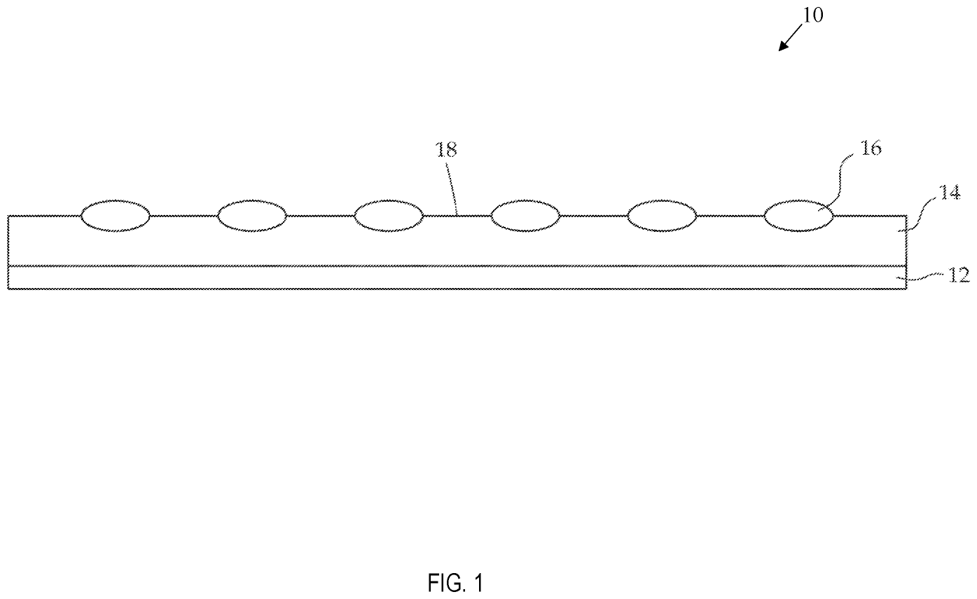

With reference to FIGS. 1-3, examples of lithium metal composite anodes of the disclosed subject matter include at least a portion of lithium metal and at least one type of hydrophilic matter. In the embodiment shown in FIG. 1, the lithium metal composite anode 10 includes a layer of a current collector, such as copper foil 12 and a layer of lithium metal (i.e., lithium metal portion 14) overlying the layer of copper foil 12. It should be understood, however, that embodiments of the disclosed subject matter are satisfactory without the current collector layer. Particles of at least one type of hydrophilic matter 16 are added to the surface 18 of lithium metal portion 14 and/or embedded throughout lithium metal portion 14. It is further noted that particles of the at least one type of hydrophilic matter 16 may be introduced to the lithium metal portion 14 via any method, including electrostatic spray deposition, brushing, atomic layer deposition (ALD), molecular layer deposition (MLD), chemical vapor deposition (CVD), physical vapor deposition (PVD), sputtering, evaporation, spin coating, thermal evaporation, stamping, and/or any other solid phase and gas phase application method.

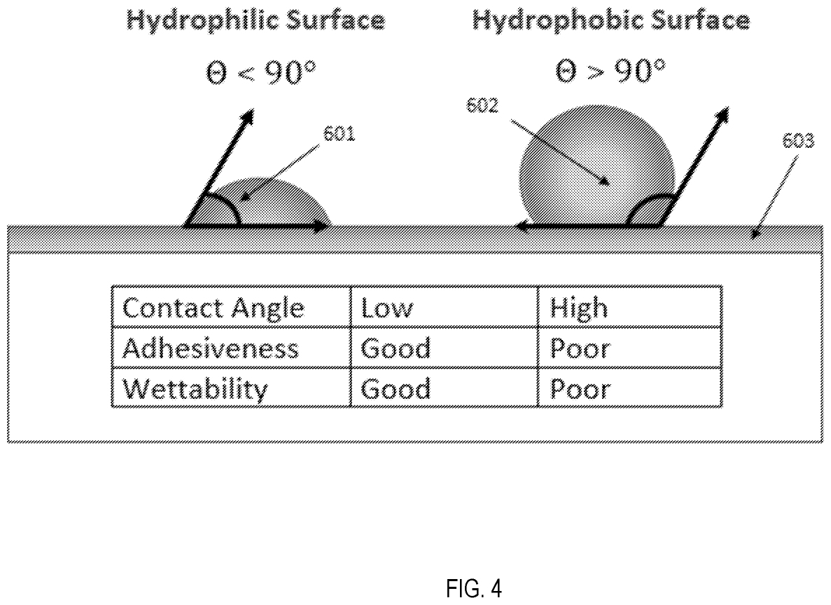

As used herein, a hydrophilic matter may include a substance from any one of: (i) hydrophilic functional groups such as hydroxyl (—OH), carbonyl (—C═O), carboxyl (—COOH), amino, sulfhydryl, or phosphate groups: (ii) hydrophilic linkages such as ether, ester, phosphodiester, or glycosidic linkages, as well as peptide bonds; and (iv) other hydrophilic structures such as an amino (—NH₂) structure, ammonia/ammonium (═NH), ammonium cations (NR⁴⁺), and the like. In addition, a hydrophilic matter may include any material, particles(s), molecule(s), or substance, that when combined with lithium metal, causes the molecules (and/or droplets) of a liquid electrolyte to form a contact angle of less than 90 degrees with the surface of the lithium metal composite. As used herein, a liquid electrolyte may include any non-aqueous liquid electrolyte including, but not limited to, a carbonate-based liquid electrolyte, an ether-based liquid electrolyte, and an ionic liquid electrolyte. The disclosed subject matter herein may also function with a polymer electrolyte including a free-standing electrolyte membrane. An exemplary illustration of a hydrophilic surface is shown in FIG. 4. Notably, FIG. 4 illustrates that a low contact angle 601 is associated with a hydrophilic surface and is indicative of a surface's good wettability. In contrast, high contact angle 602 is typically associated with a hydrophobic surface and is indicative of a surface's poor wettability. It should also be noted that the hydrophilic matter 16 embedded on the lithium metal as shown in FIG. 1 can comprise a single type of hydrophilic matter (e.g., —OH particles) or multiple types/species/groups of hydrophilic matter (e.g., —OH particles and —COOH particles). It is understood that FIG. 1 illustrates an example embodiment depicting the use of a hydrophilic matter comprising solid particles and does not limit the scope of disclosed subject matter with regard to the application of other types of hydrophilic matter (e.g., liquid particles and/or gaseous particles).

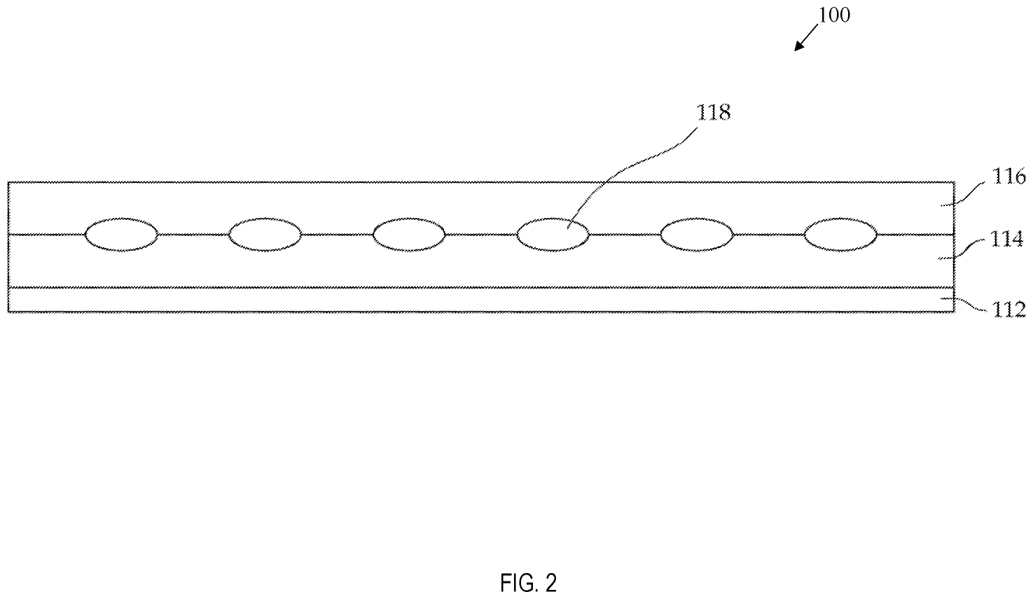

In the example embodiment of FIG. 2, the lithium metal composite anode 100 includes a layer of copper foil 112, a first layer of lithium metal 114 overlying the layer of copper foil 112, and a second layer of lithium metal 116 overlying the first layer of lithium metal 114, thereby forming a laminate structure 120. Particles of at least one type of hydrophilic matter 118 is added and/or embedded between the first layer of lithium metal 114 and the second layer of lithium metal 116. For example, the particles of the at least one type of hydrophilic matter may be introduced to the lithium metal 114 via any method described above with respect to FIG. 1 (e.g., ESD, brushing, ALD, MLD, CVD, PVD, sputtering, evaporation, spin coating, thermal evaporation, stamping, etc.). Like FIG. 1, it is understood that FIG. 2 illustrates an example embodiment depicting the use of a hydrophilic matter comprising solid particles and does not limit the scope of disclosed subject matter with regard to applying other types of hydrophilic matter (e.g., liquid particles and/or gaseous particles).

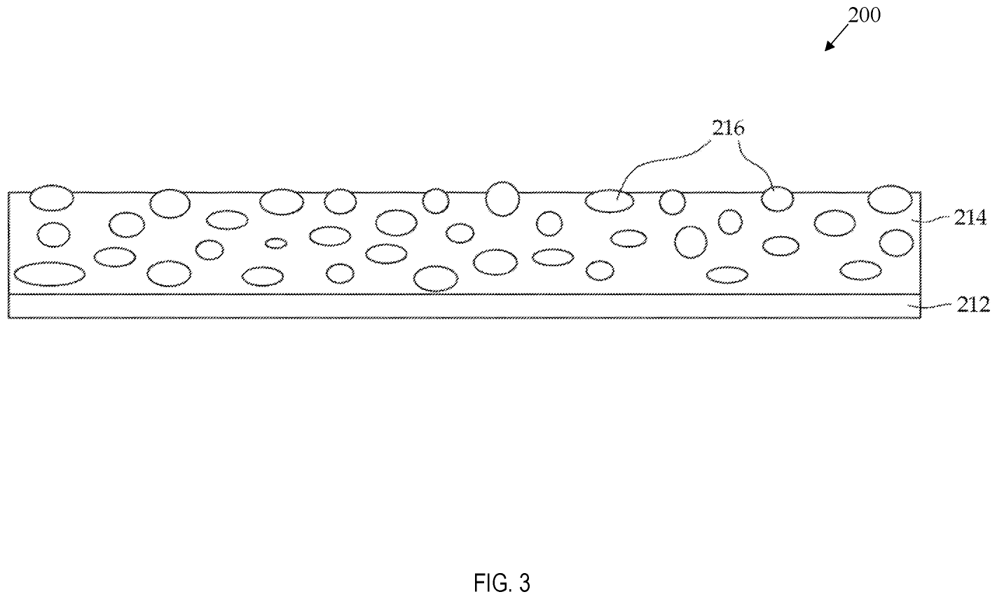

In the example embodiment of FIG. 3, the lithium metal composite anode 200 includes a layer of copper foil 212 and a layer of lithium metal 214 overlying the layer of copper foil 212. Particles of at least one type of hydrophilic matter 216 are dispersed (randomly and/or intentionally) throughout the layer of lithium metal 214 and on the surface of the lithium layer 214. In some embodiments, particles of the hydrophilic matter 216 is introduced into and throughout the lithium metal 214 via absorption after being topically applied to the surface of the lithium metal 214 via any technique, including but not limited to, ESD, brushing, ALD, MLD, CVD, PVD, sputtering, evaporation, spin coating, thermal evaporation, stamping, and the like. Like FIG. 1 and, it is understood that FIG. 3 illustrates an example embodiment depicting the use of a hydrophilic matter comprising solid particles and does not limit the scope of disclosed subject matter with regard to applying other types of hydrophilic matter (e.g., liquid particles and/or gaseous particles).

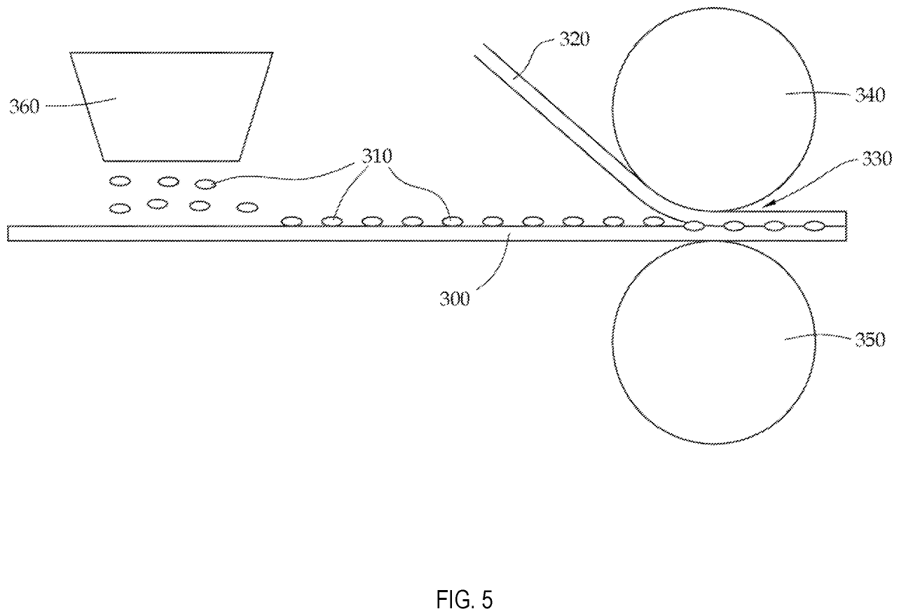

One example process of making a lithium metal composite anode of the disclosed subject matter is generally described as a roll coating process in which particles (for example, solid particles) of the hydrophilic matter are distributed, added, or deposited onto the surface of a layer of lithium metal material. The coated lithium metal may then be introduced into a nip formed between two press rollers to at least partially press or embed the hydrophilic matter into the layer of lithium metal material. In FIG. 5, the example process may include the steps of: (1) providing a first layer 300: (2) adding, depositing, or otherwise distributing particles of at least one type of hydrophilic matter 310 onto the surface of the first layer 300 (e.g., via an application device 360, such as electrostatic spray deposition device): (3) providing a second film layer 320 into contact with the hydrophilic matter 310 to “sandwich” or laminate the hydrophilic matter 310 between the first layer 300 and the second film layer 320, wherein at least one of the layers comprises lithium metal or a lithium metal alloy; and (4) passing the first layer 300 and the second film layer 320 with the particles of the at least one type of hydrophilic matter 310 laminated therebetween through a nip 330 formed between an upper press roller 340 and a lower press roller 350 to at least partially attach, press, or embed the at least one type of hydrophilic matter 310 into and/or throughout the lithium metal or lithium metal alloy. This process of solid-state application may be considered a “direct” application process, in that the solid-state application process of the multifunctional hydrophilic matter (i.e., “multifunctional” in this context means an additive to the lithium metal beyond the purpose of reducing the coefficient of adhesion of the lithium metal so that it does not become stuck on the rollers) occurs directly onto the portion of lithium metal. Notably, it is understood that FIG. 5 illustrates an example embodiment depicting the use of a hydrophilic matter comprising solid particles and does not limit the scope of disclosed subject matter with regard to applying other types of hydrophilic matter (e.g., liquid particles and/or gaseous particles).

In some embodiments of the example process depicted in FIG. 5, the first lithium metal layer 300 may be a layer of lithium metal, a layer of lithium alloy, a layer of lithium metal supported by a polymer substrate, or a polymer substrate. Similarly, the second film layer 320 may be a layer of lithium metal, a layer of lithium metal alloy, a layer of lithium metal supported by a polymer substrate, or a layer of polymer substrate. It is preferable as an element of the disclosed subject matter that at least one of film layers include pure lithium metal in direct contact with the particles of the at least one type of hydrophilic matter 310. As used in this context, “pure” lithium is considered acceptable if it is substantially comprising of only lithium, considered as 99.9% or more of lithium metal.

The step of depositing, adding, or otherwise distributing the particles of at least one type of hydrophilic matter 320 onto the surface of the first lithium metal layer 300 may be accomplished, as shown in the example embodiment of FIG. 5 by passing the first lithium metal layer 300 under an application device 360 (e.g., a feeder device, spray device, or the like) containing particles of at least one type of hydrophilic matter 310. The application device 360 may be a dry powder feeder device, a spray device, or other manner of distribution apparatus as known in the art, depending on whether the hydrophilic matter 310 is to be applied in dry form. In alternate embodiments, application device 360 can be configured to apply the particles of hydrophilic matter 310 to the lithium metal via brushing, ALD, MLD, CVD, PVD, sputtering, evaporation, spin coating, thermal evaporation, stamping, or the like.

Moreover, the hydrophilic matter 310 may be deposited onto a first film layer which acts as a transfer layer. In this specific embodiment, the first film layer may be, for example (but not intended to be a limitation), a polymer substrate to act as a transfer layer and the second layer may include the layer of lithium metal or lithium metal alloy. As the film layers are passed through the press rollers, particles of the at least one type of hydrophilic matter are transferred from the surface of the first film layer onto the exterior surface layer of lithium metal or metal alloy.

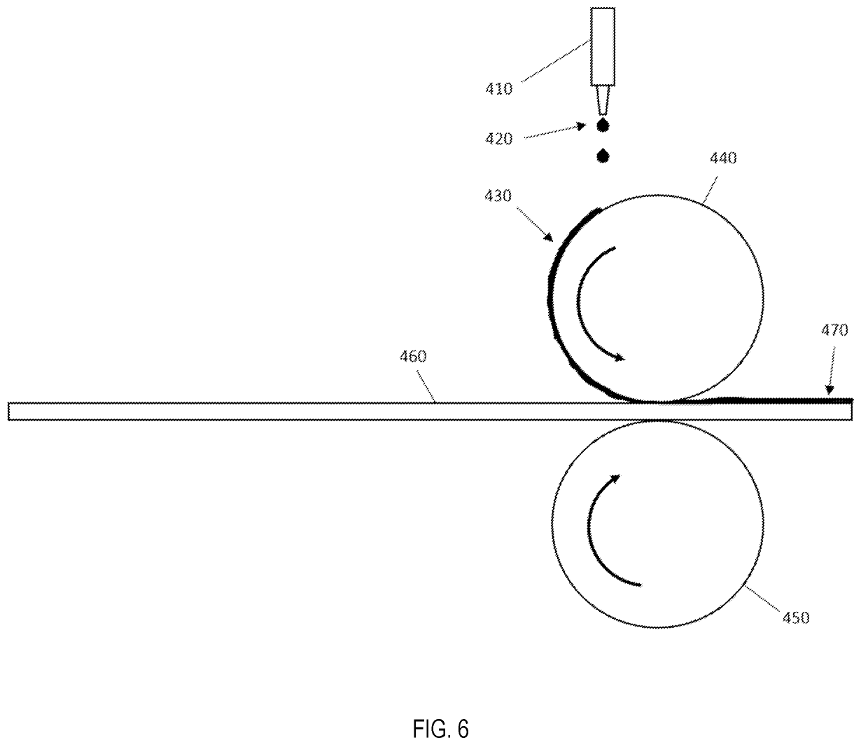

In one embodiment as shown in FIG. 6, one or more types of hydrophilic matter may be applied to a portion of lithium metal via a liquid lubricant. For example, the example process depicted in FIG. 6 may include the steps of: (1) providing a lithium metal film layer 460: (2) utilizing an application device 410 to deposit a liquid lubricant 420 containing particles of at least one type of hydrophilic matter, either directly (e.g., applied directly to the surface of lithium metal 460) or indirectly (e.g., applied directly to the surface of a upper press roller 440 that subsequently transfers the lubricant liquid 430 to the lithium metal film layer 460 as shown in FIG. 6) onto the surface of the lithium film layer 460; (3) passing the lithium metal film layer 460 with the applied liquid lubricant (i.e., containing particles of the hydrophilic matter) through a nip or spacing formed between the upper press roller 440 and a lower press roller 450 to at least partially attach, press, spread, and/or embed the particles of the hydrophilic matter into and/or throughout the lithium metal film layer 460. Notably, the liquid lubricant forms a thin layer 470 on the surface of the lithium metal film layer 460. In some embodiments, thin layer 470 may serve to apply the hydrophilic matter onto and/or into lithium metal film layer 460 via absorption and/or adsorption before or after the solvent of the liquid lubricant (and any other moisture) dries/evaporates. For example, after all of the solvent of the liquid lubricant (and any other moisture) evaporates away from lithium metal film layer 460.

Additionally, or in the alternative, the resulting lithium metal composite depicted in FIGS. 1-3 and 5-6 may have particles of at least one type of hydrophilic matter embedded into the width of the first lithium metal layer without any need to fold the lithium metal and film layers upon themselves, due to being pressed through the nip. Once the desired lithium metal composite anode structure is obtained, the lithium layer may be laminated to a copper foil or other material suitable for use as a current collector. Alternatively, the resulting anode structure may be mounted to a transfer layer and need not include the current collector as may be desired.

Suitable materials for use as the polymer substrate film layer may be of any suitable film layer, with polyolefin polymers such as polyolefin and polypropylene being particularly preferred. The term “polymers” as used herein includes both homopolymers and copolymers. The polymer substrate film layers used in the present disclosed subject matter may be unoriented or oriented in either the machine direction, the cross direction or biaxially oriented film layers. Similarly, the films layers may be monolayer materials or laminated film layers, such as polypropylene/polyethylene/polypropylene tri-layer film.

As indicated above, the hydrophilic matter may include substances characterized by chemical structures of one or more of the following types: hydrophilic functional groups such as hydroxyl (—OH), carbonyl (—C═O), carboxyl (—COOH), amino, sulfhydryl, or phosphate groups: hydrophilic linkages such as ether, ester, phosphodiester, or glycosidic linkages, as well as peptide bonds; and other hydrophilic structures such as an amino (—NH₂) structure, ammonia/ammonium (═NH), ammonium cations (NR⁴⁺), and the like. Further, porous materials such as silica, Al2O3, and zeolite, polymeric materials defined as ionomers, metal nanoparticles such as Au, and Ag nanoparticles, and materials whose surface has been treated using plasma or corona techniques constitute hydrophilic matter that would lead to improved performance of the lithium metal composite anode.

In some embodiments, the hydrophilic matter may also satisfy at least one or more of the following criteria:
(a) is at least partially soluble in non-aqueous electrolytes, including liquid:
(b) causes a change in viscosity of the electrolyte after activating:
(c) causes a change in ionic conductivity after activating;
(d) causes a change in lithium diffusion coefficient after activating: or
(e) causes a more uniform surface topography after activation.
(f) cause molecules a liquid electrolyte to form a contact angle of less than 90 degrees with the lithium metal composite anode.

As indicated above, the disclosed subject matter relates to a hydrophilic lithium metal composite anode that comprises a portion of lithium metal and at least one type of hydrophilic matter. The following description further details the improved performance of the disclosed hydrophilic lithium metal composite anode as compared to a bare/pure lithium metal anode. Particles of the hydrophilic matter can be applied to the lithium metal composite anode in various ways, including, but not limited to, a two-dimensional layered application, a three-dimensional structure, and/or via a partial or full gradient concentration. Notably, the hydrophilic lithium metal composite anode demonstrates outstanding battery performance when compared to any other lithium metal anode or lithium metal alloy anode.

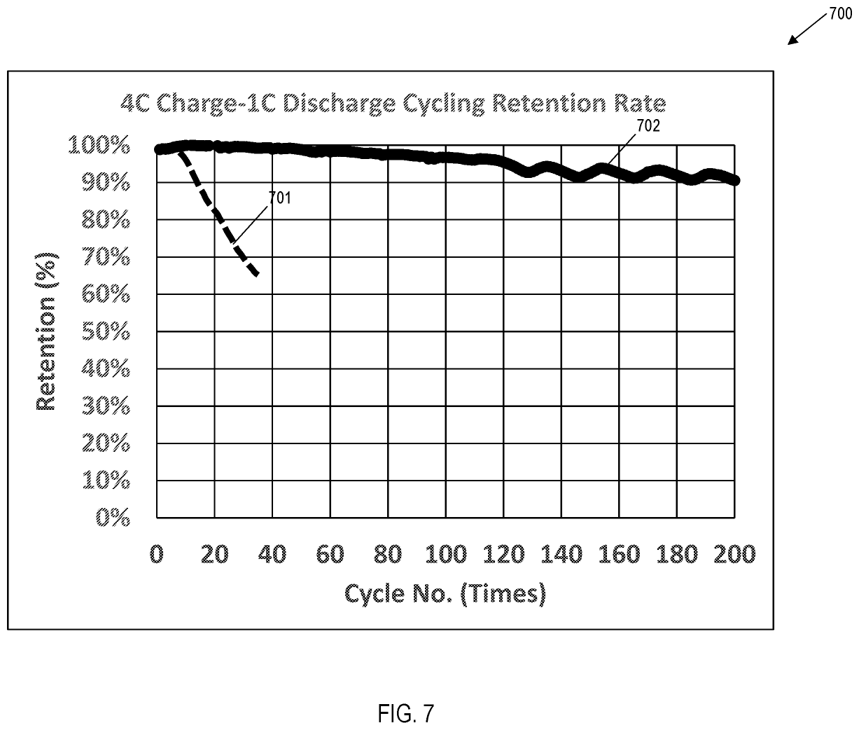

To illustrate, two different coin battery cell devices were assembled and subsequently tested to assess each battery cell's 4C cycling retention rate (e.g., 4C Charge-IC Discharge). The first battery cell comprises a pure (and commercially available) lithium metal electrode that is hydrophobic, while the second battery cell comprises a lithium metal composite anode that includes a hydrophilic matter. Both of the coin battery cells contained a standard carbonate-based liquid electrolyte and a LiNi0.8Mn0.10Co0.10 O2 (NMC) cathode. Likewise, each battery cell was charged at 4.3V in 15 minutes and then discharged at 3.0V for an hour. Referring to plot 700 of FIG. 7, plot line 701 indicates that the discharge capacity retention percentage performance of the first battery cell (i.e., the hydrophobic cell) with commercial lithium metal anode began to decrease promptly and significantly (e.g., 100%->65% after 38 cycles). In contrast, plot line 702 indicates that the retention percentage performance of the second battery cell (i.e., the hydrophilic cell) with the disclosed lithium metal composite anode retained about 90% of discharge capacity over 200 cycles. In conclusion, plot 700 indicates that battery cells equipped with hydrophilic lithium metal anodes exhibit significantly better discharge capacity retention as compared to battery cells with conventional lithium metal anodes.

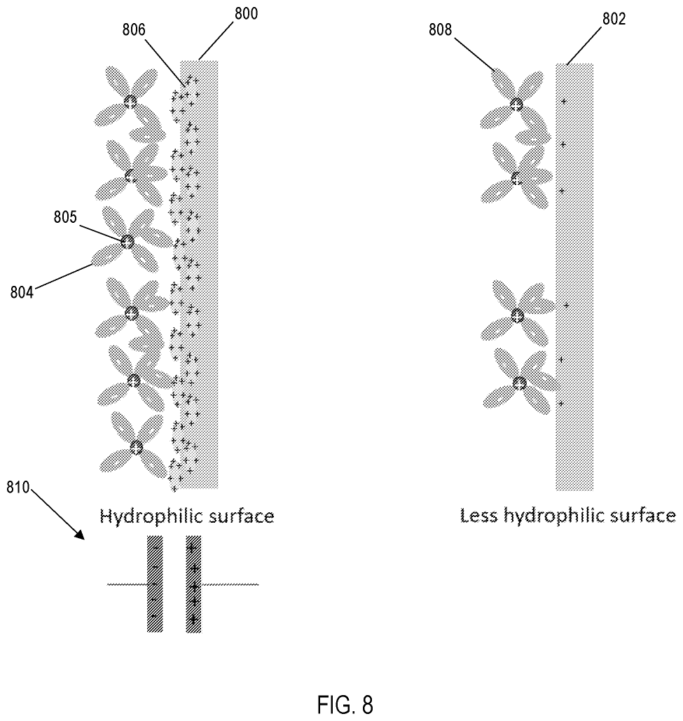

Referring to FIG. 8, a lithium metal composite anode 800 is shown to include particles of a hydrophilic matter 806 that are embedded on the electrode surface and contained within. Further, the lithium metal composite anode 800 is in contact with a liquid electrolyte that comprises organic solvent 804 and lithium ions 805. As the hydrophilicity of lithium metal composite anode 800 increases (i.e., addition of an increasing amount of hydrophilic particulate matter 806), the positive (+) polarity associated with the anode surface attracts the negatively charged particles of the liquid electrolyte solvent 804. The resultant attraction existing at the surface of the hydrophilic anode forms a double electrochemical layer (i.e., capacitance) that effectively functions as a capacitor (e.g., see hydrophilic surface diagram 810). This effect can be further distinguished from the bonding formed by a conventional lithium metal anode 802 (without any hydrophilic matter) and the particles of the liquid electrolyte solvent 808. Notably, a significantly smaller number of particles are attracted to the surface of anode 802, thereby failing to create the double electrochemical layer shown in diagram 810.

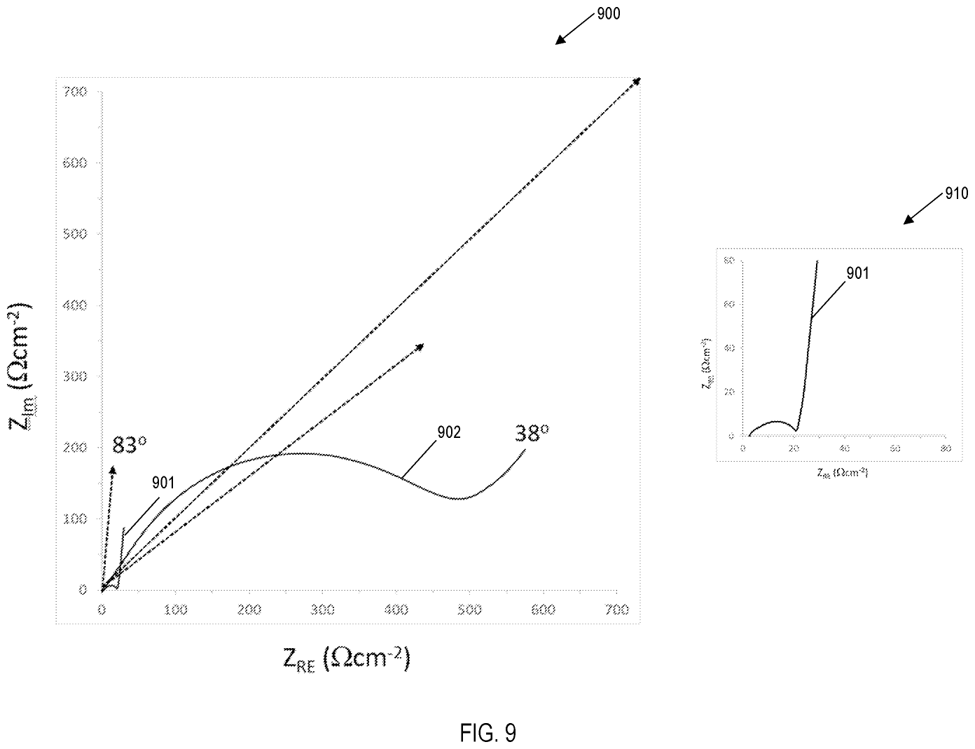

FIG. 9 presents a Nyquist plot 900 that depicts evidence of the hydrophilicity enhancement as applied to the surface of lithium metal. After assembling a first coin battery cell, impedance analysis was performed prior to conducting the charging/discharging process. For example, when impedance of the battery cell was measured, Nyquist plot 900 was generated to illustrate the affinity between the anode surface and the liquid electrolyte. Notably, Nyquist plot 800 has an x-axis indicates ohmic resistance while the y-axis is representative of reactance (e.g., due to capacitance). As shown in FIG. 9, the slope of plot line 901 in the low frequency region of the Nyquist plot 900 demonstrates a significant increase in reactance. A more detailed view of this low frequency area and plot line 901 are depicted in plot 910. By measuring the slope of plot line 901 to be 83 degrees, the associated hydrophilic battery cell can be evaluated as having a high degree of hydrophilicity existing at the interface of the lithium metal composite anode. More specifically, the steeper slope of plot line 901 in the low frequency region indicates lower impedance, which can be indirectly equated to a higher degree of wettability (and/or hydrophilicity). In contrast, the slope of plot line 902 (which is associated with the bare lithium metal anode) is shown to be much less steep at 38 degrees. The larger semi-circle (i.e., first curve formed by plot line 902) indicated in plot 900 can be attributed to a higher charge transfer resistance originating from the byproducts that are present in the interfacial area existing between the lithium metal anode and the liquid electrolyte. Accordingly, slopes of plot lines 901 and 902 reflect and/or indicate that the lithium metal composite anode has considerably higher hydrophilic surface as compared to the bare lithium anode.

One possible reason for the high hydrophilicity exhibited by the disclosed subject matter may be attributed to the stabilization of PF5 anions at the surface of the lithium metal composite anode. Notably, the anode surface may promote the decomposition of a liquid electrolyte. Returning to FIG. 8, the embedded particles of the hydrophilic matter of the disclosed subject matter have a strong interaction with the PF5 anions. Such an interaction reduces the ongoing and continuous side-reaction of decomposition of PF5 (i.e., electrolyte byproduct that typically promotes dendrite production). As such, the disclosed lithium metal composite anode containing at least one type of hydrophilic matter can effectively suppress lithium dendrite growth in lithium battery cells.

In another experiment, two lithium metal battery cells were prepared. The first battery cell comprised a conventional lithium anode while the second battery cell comprised a lithium metal composite anode, which included a hydrophilic matter. The battery cells were subjected to sequential stripping/plating cycles conducted at 1 mA/cm² for one hour per cycle. Tests were conducted in an electrolyte solution of ethylene carbonate (EC):diethyl carbonate (DEC) [1:2, v:v] in 1M LiPF₆. In some embodiments, the composition of the used comprises: 1M LiPF₆ in EC/DEC/FEC (25/70/5, vol %).

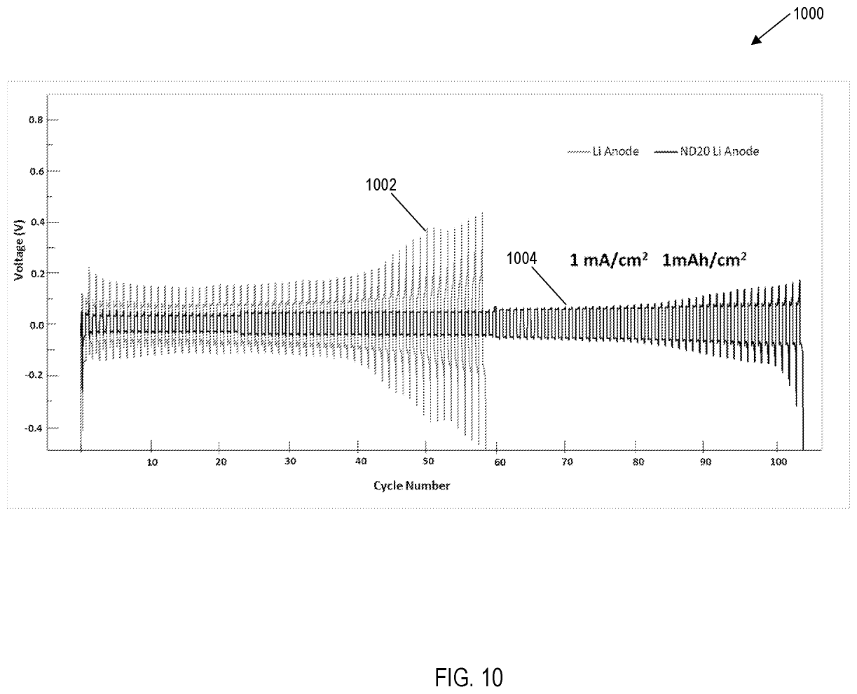

The voltage of each battery cell was measured during the repeated stripping and plating cycles. Results are illustrated in graph 1000 of FIG. 10, which depict that the hydrophobic lithium metal battery cell (represented by plot line 1002) exhibited a larger voltage instability during the lithium deposition and dissolution stages (e.g., stripping stages). Specifically, plot line 1002 indicates that the voltage of the hydrophobic lithium metal battery cell exhibited increased polarization above 400 millivolts (mV) during cycling. In contrast, the hydrophilic lithium metal composite anode (indicated by plot line 104) was very stable and demonstrated a polarization of 100 mV up to approximately 85 cycles. With the exception of the last one or two cycles, the hydrophilic lithium metal composite anode never exhibited voltage instability to the degree demonstrated by the hydrophobic lithium metal anode.

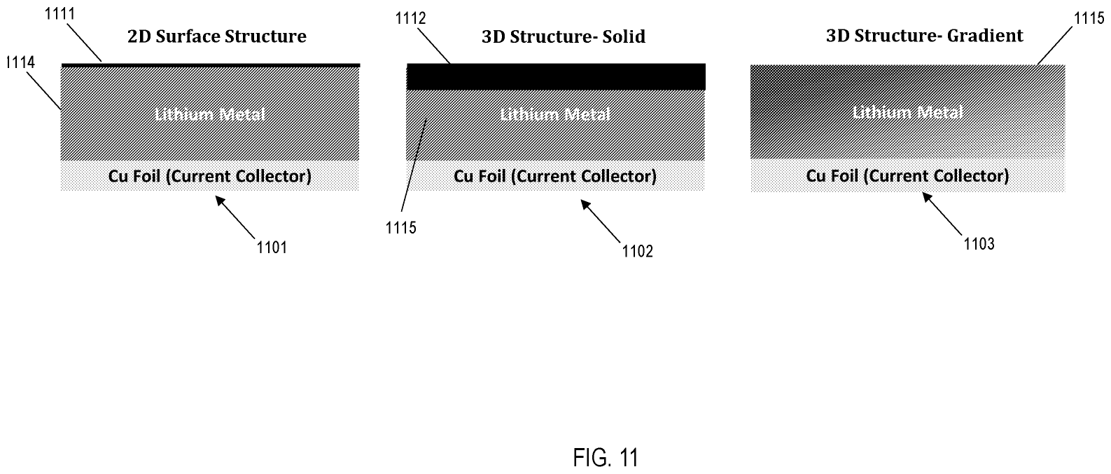

As indicated above, the disclosed lithium metal composite anode comprises a pure lithium metal portion that includes the addition of at least one type of hydrophilic matter. Notably, the hydrophilic matter can be applied to the lithium metal portion in a variety of ways. For example. FIG. 11 depicts three exemplary structural addition of hydrophilic matter. Lithium metal composite anode 1101 comprises a lithium metal layer 1114 that is positioned over top a current collector layer (e.g., copper foil). In some embodiments, hydrophilic matter can be applied as a thin two-dimensional (2D) surface structure layer 1111 atop the lithium metal layer 1114 of lithium metal composite anode 1101. In particular, layer 1111 comprises hydrophilic matter that is embedded, adhered, deposited, sprayed, and/or applied to the surface of lithium metal layer 1114 as a thin coating and/or thin layer. In some embodiments, layer 1111 may be as thin a single particle (e.g., atom or molecule) of the applied hydrophilic matter. For example, layer 1111 may be one angstrom in thickness.

Similarly. FIG. 11 depicts a lithium metal composite anode 1102 as comprising a lithium metal layer 1115 that is positioned over top a current collector layer (e.g., copper foil). Hydrophilic matter can be applied to lithium metal composite anode 1102 as a thick three-dimensional (3D) surface structure layer 1112 atop the lithium metal layer 1115. In particular, layer 1112 comprises hydrophilic matter that is embedded, adhered, deposited, sprayed, and/or applied to the surface of lithium metal layer 1114 to form a solid structure and/or thick top layer. In some embodiments, layer 1112 may range from one nanometer (nm) to 100 micrometers (μm) in thickness.

FIG. 11 further depicts a lithium metal composite anode 1103 as comprising a lithium metal layer 1115 that is positioned over top a current collector layer (e.g., copper foil). Hydrophilic matter can then be applied to lithium metal composite anode 1103 as a three-dimensional structure but in a gradient manner. For example, lithium metal layer 1115 may include multiple pores and/or indentations that are configured to receive applied hydrophilic matter. Notably, each of these pores are configured to receive different concentrations of hydrophilic matter via gradient layers (e.g., hydrophilic matter contained throughout the lithium metal layer). In some embodiments, the gradient layers can be formed by multiple or repeatable composite lithium metal processes. Notably, the gradient structure described herein may be designed to gradually increase or decrease the amount of hydrophilic matter in the lithium metal composite anode depending upon electrolyte properties such that a battery cell including the hydrophilic lithium metal composite anode maintains the enhanced performance for a longer period of time.

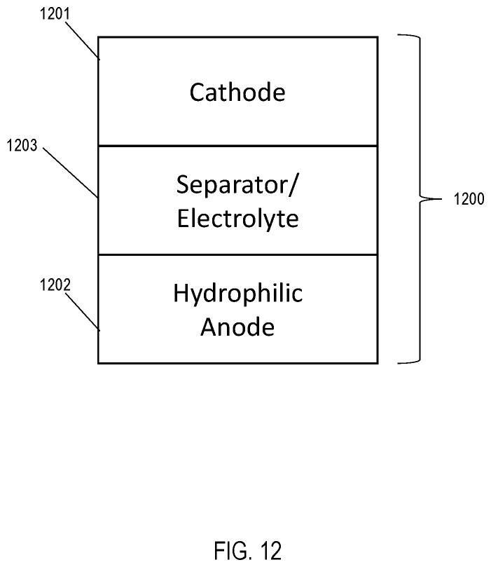

In some embodiments, the disclosed hydrophilic composite lithium metal anode can be incorporated into a battery cell. For example. FIG. 12 illustrates an example battery cell device 1200 that may include a cathode 1201, a lithium metal composite anode 1202, and a separator 1203 (containing electrolyte). Notably, lithium metal composite metal anode includes at least one type of hydrophilic matter that has been added in the manner described above. In some embodiments, the battery cell device 1200 may further include a non-aqueous liquid electrolyte (for example, any carbonate-based electrolyte, ether-based electrolyte, ionic liquid electrolyte, etc.) that is contained in separator 1203 and absorbed at the surface of the hydrophilic composite lithium metal anode 1202. Alternatively, the electrolyte may instead comprise a polymer electrolyte that includes a free-standing electrolyte membrane that is similarly absorbed by lithium metal composite anode 1202. Examples of battery cells that can utilize the disclosed hydrophilic composite lithium metal anode include a lithium-ion battery cell, a lithium metal battery cell, a polymer-electrolyte based all solid-state battery cell, a lithium sulfur battery cell, a lithium air battery cell, or the like.

The embodiments shown and described in the preceding description are for illustration and explanation only and are not intended to limit the scope of the disclosed subject matter in the appended claims.

What is claimed is:

1. A method of forming a lithium metal composite anode for a battery, the method comprising:
providing a portion of lithium metal; and
adding at least one type of hydrophilic matter to the portion of lithium metal to adhere or embed the at least one type of hydrophilic matter to or into the portion of lithium metal to form a lithium metal composite anode.

2. The method of claim 1 wherein the lithium metal composite anode exhibits hydrophilic properties.

3. The method of claim 1 wherein the at least one type of hydrophilic matter comprises particles of one or more of a hydroxyl (—OH) group, a carbonyl (—C—O) group, a carboxyl (—COOH) group, and amino group, a sulfhydryl group, a phosphate group, an ether linkage, an ester linkage, a phosphodiester linkage, a glycosidic linkage, a peptide bond, an amino (—NH₂) structure, an ammonia/ammonium (═NH) structure, and ammonium cations (NR⁴⁺).

4. The method of claim 1 wherein a portion of an electrolyte applied to the lithium metal composite anode interfaces with a surface of the lithium metal composite anode at a contact angle less than ninety (90) degrees.

5. The method of claim 4 wherein the electrolyte includes a carbonate-based liquid electrolyte, an ether-based liquid electrolyte, an ionic liquid electrolyte, or a polymer electrolyte including a free-standing electrolyte membrane.

6. The method of claim 4 wherein the electrolyte includes a polymer-based electrolyte comprising a plasticizer.

7. The method of claim 1 wherein the at least one type of hydrophilic material is added to the portion of lithium metal via electrostatic spray deposition (ESD), brushing, atomic layer deposition (ALD), molecular layer deposition (MLD), chemical vapor deposition (CVD), physical vapor deposition (PVD), sputtering, evaporation, spin coating, thermal evaporation, stamping, or combinations thereof.

8. The method of claim 1 wherein the portion of lithium metal comprises pure lithium metal, a lithium composite, a lithium alloy, or a lithium metal supported by a polymer substrate.

9. The method of claim 1 wherein the at least one type of hydrophilic matter is dispersed and embedded throughout the portion of lithium metal.

10. A lithium metal composite anode comprising:
a portion of lithium metal; and
at least one type of hydrophilic matter, wherein the at least one type of hydrophilic matter is added to the portion of lithium metal to adhere or embed the at least one type of hydrophilic matter on or in the portion of lithium metal.

11. The lithium metal composite anode of claim 10 wherein the addition of the at least one type of hydrophilic matter to the portion of lithium metal produces a lithium metal composite anode that exhibits hydrophilic properties.

12. The lithium metal composite anode of claim 10 wherein the at least one type of hydrophilic matter comprises particles of one or more of a hydroxyl (—OH) group, a carbonyl (—C—O) group, a carboxyl (—COOH) group, and amino group, a sulfhydryl group, a phosphate group, an ether linkage, an ester linkage, a phosphodiester linkage, a glycosidic linkage, a peptide bond, an amino (—NH₂) structure, an ammonia/ammonium (═NH) structure, and ammonium cations (NR⁴⁺).

13. The lithium metal composite anode of claim 10 wherein a portion of an electrolyte applied to the lithium metal composite anode interfaces with a surface of the lithium metal composite anode at a contact angle less than ninety (90) degrees.

14. The lithium metal composite anode of claim 13 wherein the electrolyte includes a carbonate-based liquid electrolyte, an ether-based liquid electrolyte, an ionic liquid electrolyte, or a polymer electrolyte including a free-standing electrolyte membrane.

15. The lithium metal composite anode of claim 13 wherein the electrolyte includes a polymer-based electrolyte comprising a plasticizer.

16. The lithium metal composite anode of claim 10 wherein the at least one type of hydrophilic material is added to the portion of lithium metal via electrostatic spray deposition (ESD), brushing, atomic layer deposition (ALD), molecular layer deposition (MLD), chemical vapor deposition (CVD), physical vapor deposition (PVD), sputtering, evaporation, spin coating, thermal evaporation, stamping, or combinations thereof.

17. The lithium metal composite anode of claim 10 wherein the portion of lithium metal comprises pure lithium metal, a lithium composite, a lithium alloy, or a lithium metal supported by a polymer substrate.

18. The lithium metal composite anode of claim 10 wherein the at least one type of hydrophilic matter is dispersed and embedded throughout the portion of lithium metal.

19. A battery cell comprising:
a cathode;
an electrolyte;
a separator that contains the electrolyte; and
a lithium metal composite anode including a portion of lithium metal and at least one type of hydrophilic matter, wherein the at least one type of hydrophilic matter is added to the portion of lithium metal to adhere or embed the at least one type of hydrophilic matter on or in the portion of lithium metal, and wherein the lithium metal composite anode exhibits hydrophilic properties when in contact with the electrolyte.

20. The lithium metal battery cell of claim 19 wherein the lithium metal composite anode is incorporated within a lithium-ion battery cell, a lithium metal battery cell, a polymer-electrolyte based all solid-state battery cell, a lithium sulfur battery cell, a lithium air battery cell, or the like.
